(19) United States
(12) Patent Application Publication
(10) Pub. No.: US 2026/0365477 A1
(43) Pub. Date: Nov. 19, 2026

(54) BELT-MAGAZINED ELEMENT COIL, A SUPPLY DEVICE, A COILING DEVICE AND A PROCESSING DEVICE WITH SAME AS WELL AS A COILING METHOD OF THE ELEMENT COIL AND A LOADING METHOD OF THE PROCESSING DEVICE

(71) Applicant: Böllhoff Verbindungstechnik GmbH, Bielefeld (DE)

(72) Inventors: Dennis HENKE, Herzebrock-Clarholz (DE); Alexander KEHRER, Werther (DE)

(21) Appl. No.: 19/661,359

(22) Filed: Apr. 28, 2026

(30) Foreign Application Priority Data
May 8, 2025 (EP) 25175074.1

(51) Int. Cl. B65H 75/22; B21J 15/32; B25B 23/04

(52) U.S. Cl. CPC B65H 75/2254; B21J 15/323; B25B 23/045; B65H 75/2245

(57) ABSTRACT

A belt-magazined element coil to which a belt band with small-scale elements that are releasably fastened in it can be coiled and which includes: a hollow-cylindrical coil core with a central longitudinal axis and a first and a second axial end onto which the belt band can be coiled and uncoiled in a controlled manner and which is arranged on an axis accommodation for carrying out a rotating coiling movement, a preferably annular side wall is arranged at the ends of the coil core, which laterally delimit a coiling space for the belt band, the coil core and/or at least one of the side walls are designed such that a mechanical connection between the axis accommodation and the coil is enabled such that at least a first complementary object at the coil and at least a second complementary object at the axis accommodation engage one another.

### 1. FIELD OF THE INVENTION

The present invention is related to an element coil, onto which elements, preferably connecting elements, that are magazined in a belt, i.e. releasably arranged in same, can be coiled. Furthermore, the present invention relates to a supply device of a processing device of small-scale elements, preferably a setting device for connecting elements, in which at least a belt-magazined element coil can be arranged and can be uncoiled for the supply of a small-scale element to the processing device. Furthermore, the present invention relates to a processing device of small-scale elements which may be supplied with the help of the belt-magazined element coil to the processing device. In order to load the element coil with belt-magazined elements, a coiling device for a belt equipped with small parts which are releasable from same, in particular connecting elements, as well as a coiling method for an element coil are described. Finally, the present invention discloses a loading method of the processing device with which the belt-magazined element coil is arrangeable ready to be operated in the supply device of the processing device.

### 2. BACKGROUND OF THE INVENTION

In the machine construction of the most various application fields, small-scale elements, e.g. connecting elements, are processed. Punch rivets, blind rivet nuts and the like are automatically supplied to a processing device. It is known that punch rivets of a large variety of geometries are respectively supplied via a pressurized air channel to the processing setting device so as to be set subsequently.

Alternatively to a pressurized air channel, small-scale elements are stored in a belt or magazined there and then coiled on an element coil.

In automatization machines, such element coils are automatically loaded into a processing device.

Before loading the element coil into the processing device, it must be determined whether the small-scale elements which match the processing device are stored on the element coil.

Common determination methods, which for example operate with RFID recognition of the small-scale elements, are prone to breakouts and lead to a wrong loading of the processing device.

EP 3 666 702 B1 discloses a coil onto which wires of a wide variety of configurations and features can be coiled. In order to identify the coiled wire, a face side of the wire coil comprises webs arranged in a circle, and interim spaces, which identify the coiled wire by means of size and arrangement. The identifying webs can be seen from the outside and can be evaluated, so that the coil with the required wire can be selected.

Accordingly, before the coil is loaded, an identification device must read the mechanically stored wire information, interpret it and subsequently release the coil for it to be processed. This step is laborious with regard to the technical design and implementation of the method. Furthermore, these processes are time and cost intense for automated methods.

It is therefore the object of the present invention to provide a fault-reduced supply device for small-scale elements to a processing device.

### 3. SUMMARY OF THE INVENTION

The above object is solved by a belt-magazined element coil according to the independent claim 1, a supply device of a processing device, preferably a setting device, of small-scale elements according to the independent claim 9, a processing device for small-scale elements, in particular connecting element such a punch rivets, setting bolts, setting nuts, in which the small-scale elements are releasably fastened in a belt band according to the independent claim 13, a coiling device with which belt-magazined elements can be coiled onto an element coil according to the independent claim 14, a loading method of a processing device with a belt-magazined element coil according to the independent claim 15 as well as a coiling method of an element coil according to the independent claim 16. Advantageous embodiments and further developments of the present invention arise from the following description, the drawings as well as the appending claims.

The present invention discloses a belt-magazined element coil to which a belt band with small-scale elements that are releasably fastened in it, in particular connecting elements such as punch rivets, setting bolts, setting nuts, welding nuts, can be coiled and which comprise the following features: a hollow-cylindrical coil core with a central longitudinal axis and a first and a second axial end onto which the belt band can be coiled, from which the belt band can be uncoiled in a controlled manner and which is arranged on an axis accommodation torque-proof for carrying out a rotating coiling movement, a preferably annular side wall is arranged at the first and the second axial end of the coil core, which laterally delimit an intermediate coiling space for the belt band on the coil core, the coil core and/or at least one of the side walls of the coil are designed in shape such that based on a positive mechanical identification connection between the axis accommodation and the coil, a mechanical connection between same is enabled in that when arranging the coil on the axis accommodation, at least a first complementary object at the coil and at least a second complementary object at the axis accommodation suitably engage one another, by that allowing the connection instead of blocking it.

The use of belt-magazined element coils for the preferred supply of a processing device, e.g. a setting device, are known in the state of the art. These element coils are preferably made of a hollow cylindrical coil core and side walls arranged to same and axially spaced from one another. In order to be able to rotate the element coil, it is arrangeable on an axis accommodation. The element coil and the axis accommodation provide surface sections which preferably abut one another as soon as the element coil is arranged on the axis accommodation ready for operation.

The preferred abutting surface sections of element coil and axis accommodation form the constructive basis for configuring a mechanical identification connection according to the invention between the element coil and the axis accommodation. The mechanical identification connection is made of at least two complementary objects, the first complementary object being arranged at the element coil and the second complementary object being arranged at the axis accommodation.

The term complementary object refers to at least two objects which are formed complementary with regard to their shape, or at least nearly complementary. In this context, complementary requires that the two complementary formed objects are respectively configured or shaped in an almost alternating manner, without every detail having to repeat itself in the respective counterpart. In other words, the two complementary objects which match one another have the feature that due to their design, they engage one another and by that allow and form a mechanical identification connection. Accordingly, as an example, a pen fits into an opening or indentation or a convex elevation into a concave indentation or into an opening.

If the two complementary objects are not characterized by an alternating equivalent, they cannot engage one another and cannot form any identification connection. If the forming of an identification connection is hindered, the element coil is preferably not arrangeable in an operative manner on the axis accommodation or the axis accommodation is preferably not positionable in a torque-proof manner in the element coil.

According to a preferred embodiment of the present invention, the at least two mutually complementary formed first and second complementary objects at the coil and the axis accommodation, which form a suitable identification connection, are made of an elevation and an opening or indentation accommodating this elevation, each having a round or angular or curvilinear circumferential form.

To be able to connect the element coil and the axis accommodation in an operative or ready-to-operate manner, preferably, specific surface portions must be arranged adjacent or closely to each other so that preferably, a rotation movement of the element coil, supported by the axis accommodation, can take place. If these specific surface portions are not located in the matching arrangement, element coil and axis accommodation are not functionally connected with each other.

As has been described above, the mechanical identification connection is formed by at least two mutually corresponding constructive objects, specifically the complementary objects. In case of a lacking equivalent of the at least two encountering constructive objects during the preferred connecting of the element coil and the axis accommodation and thus in the attempt of establishing the mechanical identification connection, preferably, a reliable operative arrangement of the element coil on the axis accommodation is impossible. Furthermore, the identification connection which cannot be implemented shows that on the element coil, the suitable elements are not magazined, which are intended for the processing device and the axis accommodation adapted to same.

The complementary objects are formed by constructive shapes which are adapted mutually to one another. These complementary objects which are preferably provided in pairs preferably consist of a male and a female element or of a convex and a concave element or of an elevation and an indentation or receiving opening. The design and the circumferential form of the complementary objects is arbitrary within the frame of the respective equivalent.

It is furthermore preferred that the side wall of the belt-magazined element coil comprises at least a first complementary object which is arranged at a defined radial position with respect to the central longitudinal axis and at a defined circumferential position around the central longitudinal axis with respect to a lateral surface of the side wall.

According to a preferred embodiment of the present invention, the element coil with the at least one side wall is arranged on the axis accommodation. According to a preferred configuration of the present invention, the axis accommodation is formed like a T in an axial cut. The T form is preferably made of a cylindrical leg forming the axis and an attachment wall extending perpendicular to and projecting radially from same. The attachment wall provides at least one attachment surface segment to which a coil surface segment of a side wall of the element coil in an operative arrangement and connection abuts at least partially. Preferably, the mutually adapted complementary objects are arranged at these surface segment which lie opposite one another in an operative arrangement.

The complementary objects preferably serve for providing the element coil with an identification of the elements, preferably punch rivets or setting bolts, which are magazined in the belt. In order to indicate different constructive or material features or similar features of the magazine elements, the at least one complementary object is arranged at a defined radial position and a defined circumferential position of the side wall of the element coil with respect to the rotation axis of the element coil. If preferably, the side wall of the element coil is divided into radial and circumferential positions, similar to a coordinate system, preferably in a polar coordinate system, the features of the elements, which are magazined in the belt, in the complementary objects may be defined by means of preferred defined coordinate features. Only if a supply device (see below) or a processing device is supposed to process the elements equipped with these features, the corresponding axis accommodation comprises the correspondingly adapted complementary object at the defined coordinate position of the element coil. That way, different element features may be stored recognizably and read by means of a shape, a dimension, an arrangement in the coordinate system, and thus be integrated effectively into the automatization operation.

According to a further preferred embodiment of the present invention, a plurality of first complementary objects are arranged at the same radial position and different circumferential positions or at the same circumferential position and different radial positions or at combinations of the above arrangement alternatives, in order to identify a defined, small-scale element of the belt-magazined element coil.

Preferably, at least two of the plurality of first complementary objects have different forms or different dimensions of the same forms.

According to a further preferred embodiment of the present invention, the at least one first complementary object is made of an exchangeable identification attachment or insert, which interacts with an integral or an exchangeable identification attachment or insert at the axis accommodation.

According to different preferred embodiments of the present invention, the complementary objects in the element coil and the axis accommodation are provided in different ways. According to a preferred embodiment, the at least one complementary object in the element coil and/or axis accommodation is already formed during the production of element coil and/or axis accommodation. This is preferably possible when using an injection molding method or an additive manufacturing method of the element coil and/or the axis accommodation.

According to a further preferred embodiment of the present invention, the element coil and/or the axis accommodation are equipped with at least one installation opening for an identification attachment and/or an identification insert. This installation opening is preferably arrangeable individually or as a plurality in the preferred coordinate system of the element coil (see above) and the axis accommodation.

Preferably, at least one identification insert is arrangeable in each installation opening in order to form a complementary object.

Similarly, it is preferred that at least one fastening point be provided at the opposing surface segments of element coil and/or axis accommodation, to which at least one exchangeable identification attachment at a time is fastenable.

Likewise, it is certainly also preferred that a use of identification inserts and attachments and their respective fastening possibilities be combined or arranged jointly at the element coil and the axis accommodation.

In a further preferred configuration of the present invention, the at least one first complementary object is made of an exchangeable identification attachment or insert which interacts with an integral or an exchangeable identification attachment or insert at the axis accommodation.

The above-described preferred configurations of the present invention are preferably realized at the surface segments which are arranged opposite one another and extending radially with respect to a longitudinal or rotation axis of element coil and axis accommodation.

It is furthermore preferred that the hollow cylindrical coil core comprises, at a radial inside, at least a first complementary object which forms a suitable connection with at least a second complementary object at a radial outer side of the axis accommodation or is capable of blocking a connection between coil and axis accommodation.

In the construction of the present invention, a radial inside of the hollow cylindrical coil core of the element coil and a radial outside of the cylindrical axis accommodation receivable in there also form opposing surface segments so as to arrange complementary objects which interact in pairs.

The complementary objects may be formed by identification attachments on the surface or by identification inserts in indentations or by indentations in combination with identification attachments or projections or by combinations of the above alternatives.

Due to the little leeway between coil core and axis accommodation, a connection between element coil and axis accommodation can effectively be blocked by means of non-matching complementary objects.

Preferably, the at least one first complementary object at the radial inside of the hollow cylindrical coil core is made of a radially projecting identification attachment or an identification indentation or of a radially projecting identification insert that is inserted into an indentation or of a combination of same, and the at least one matching second complementary object at the radial outside of the axis accommodation is made of a suitable indentation for the identification attachment or the radially projecting identification insert or of a matching radially projecting attachment for the indentation at the coil core.

The present invention also discloses a supply device for a processing device, preferably a setting device, of small-scale elements, in particular of connecting elements, having at least an axis accommodation with at least a second complementary object matching at least a first complementary object of a belt-magazined element coil according to one of the preceding configurations and which is fastenable at the processing device.

According to a further preferred embodiment of the supply device, its axis accommodation comprises a cylindrical receiving portion for the hollow cylindrical coil core of the coil, to which radial outer side at least a second complementary object is provided as a radial projection or a radial indentation.

It is furthermore preferred that a radially extending identification wall is provided at the axis accommodation of the supply device, to which a side wall of the coil is attachable in order to form an identification connection between at least a second complementary object at the identification wall and at least a first complementary object at the side wall of the coil.

According to a further preferred configuration, the identification wall of the supply device comprises as an at least second complementary object an axial projection in axial direction of the cylindrical receiving portion or an indentation or opening in a direction facing away from the cylindrical receiving portion.

Furthermore, the present invention also discloses a processing device for small-scale elements, in particular connecting elements such as punch rivets, setting bolts, setting nuts, in which the small-scale elements are releasably fastened in a belt band, the belt band is coiled on one of the element coils constructed according to one of the above configurations and the coil with belt-magazined elements is arranged in a supply device according to one of the above configurations, wherein at least one coil with belt-magazined elements can rotatably and exchangeably be loaded on an axis accommodation into a supply device of the processing device only on the basis of a positive mechanical connection identification, so that with the help of the supply device, the small-scale elements are suppliable preferably individually to the processing device, preferably a setting device.

Moreover, the present invention discloses a coiling device with which belt-magazined elements are coilable on an element coil according to one of the preceding embodiments and which comprises an engine-driven axis accommodation with at least one second complementary object, so that a belt with belt-magazined elements may be coiled or uncoiled in a controlled manner onto or from the element coil, equipped with the at least one first complementary object matching the at least one second complementary object of the axis accommodation.

The present invention also discloses a loading method of one of the above described processing devices with at least one belt-magazined element coil according to at least one of the above configurations, having the following steps: arranging the belt-magazined element coil with at least a first complementary object on an axis accommodation, establishing an identification connection between the element coil and the axis accommodation by means of connecting the at least one first complementary object of the element coil with the at least one second complementary object of the axis accommodation, discarding the element coil when the at least one first and the at least one second complementary object do not match, or locking the element coil on the axis accommodation when the at least one first and the at least one second complementary object match each other.

Furthermore, the present invention discloses a coiling method of an element coil according to at least one of the above configurations, having the following steps: arranging the element coil with at least a first complementary object on an axis accommodation, establishing an identification connection between the element coil and the axis accommodation by connecting the at least one first complementary object of the element coil with the at least one second complementary object of the axis accommodation, discarding the element coil when the at least one first and the at least one second complementary object do not match, or locking the element coil on the axis accommodation when the at least one first and the at least one second complementary object match each other, and coiling a belt with belt-magazined elements onto the element coil so as to form a belt-magazined element coil.

### 4. SHORT SUMMARY OF THE DRAWINGS

In the following, the present invention will be described in detail based on the drawings. In the drawings, the same reference signs denote the same elements and/or components. They show:

FIG. 1 a schematic illustration of a setting device at a C frame as an example for a processing device for the belt-magazined element coil,

FIG. 2 a schematic illustration of an inventively preferred element coil in a lateral view and a top view,

FIG. 3 a schematic illustration of the element coil in combination with a preferred axis accommodation of the element coil,

FIGS. 4-7 schematic illustrations of a lateral view of the element coil with a preferred arrangement, number and design of complementary objects,

FIG. 8 a further preferred embodiment of the element coil in combination with an axis accommodation, in which the complementary objects are arranged in the coil core and at the cylindrical portion of the axis accommodation,

FIG. 9 a schematic illustration of the different design possibilities of the cylindrical portion of the axis accommodation and the complementary objects arranged to it,

FIG. 10 a further preferred configuration of the coil core of the element coil in combination with the cylindrical portion of the axis accommodation and the complementary objects in a preferred sectional view,

FIG. 11 a schematic illustration of a preferred embodiment of inserts for providing complementary objects at the element coil and/or the axis accommodation,

FIG. 12 a flow chart of a preferred design of a loading method for an element coil with belt-magazined elements and

FIG. 13 a flow chart of a preferred embodiment of a coiling method of a belt band equipped with elements onto an element coil.

### 5. DETAILED DESCRIPTION OF THE PREFERRED EMBODIMENTS

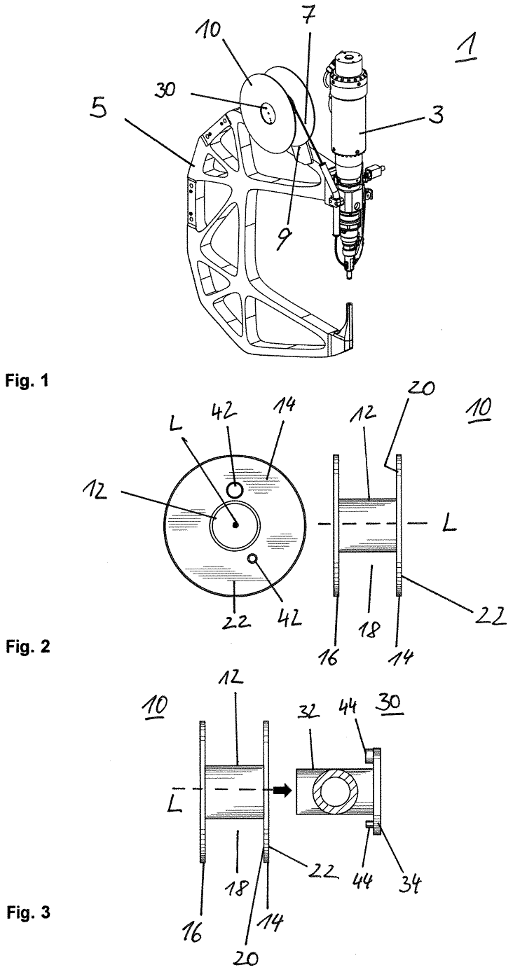

As an example, FIG. 1 shows a processing device 1 in the form of a setting device 3. The setting device 3 is fastened to a C-frame 5. Connecting elements, such as for example punch rivets, magazined in a belt band 7, are supplied to the setting device 3 with the help of an element coil 10. For this purpose, the element coil 10 is rotatably arranged on an axis accommodation 30 of a supply device 9.

In the belt band 7, which is preferably made of plastic material, a plurality of small-scale elements, such as punch rivets, bolts, screws, setting nuts, is releasably fastened. In this context, releasably fastened means that an individual element is held loss-proof in an opening of the belt band 7. In the example of a semi hollow punch rivet stored in the belt band 7, the semi hollow punch rivet can be released from the belt band 7 by means of a setting punch of the setting device 1 so as to establish a joining connection. Such supply possibilities of elements are known in the state of the art.

A retaining web 90 of the supply device 9 is preferably connected with the C-frame 5 (see FIG. 1) or with the setting device 3. It is furthermore preferred that the axis accommodation 30 is arranged at the retaining web 90 or at another retaining component of the supply device. The axis accommodation 30 retains the element coil 10 in a rotatable manner, as will be explained in more detail below. In this context, it is preferred that the axis accommodation 30 is rotatably arranged or rotatably driven by a motor.

In case of a rotatable arrangement of the element coil 10 on the axis accommodation 30, the belt band 7 is preferably pulled past the setting head of the setting device 1, in order to supply those elements, which are stored in the belt band 7, individually per setting process to the setting device. The pulling and cutting of the belt band and the associated supplying of individual elements to the processing device is described in the applications EP 23 215 929.3, EP 24 177 888.5 and EP 25 172 027.2, which are incorporated herein by taking reference to their construction and processing, e.g. of the pulling mechanism.

The preferred supply device 9 is characterized in that it may be retrofitted at a processing device 1, e.g. a setting device 3. This circumstance is interesting for processing devices 1, e.g. setting devices, to which the elements to be processed have so far been fed or supplied by means of pressurized air profile hoses or magazines.

A schematic lateral view of the element coil 10 is shown in FIG. 2 in the direction of the longitudinal axis L and in a top view perpendicular to the longitudinal axis L. The element coil 10 comprises a coil core 12, which is preferably configured hollow-cylindrically. The central longitudinal axis L which has already been mentioned above and about which the element coil 10 rotates when coiling on and unwrapping the belt band 7, extends in longitudinal direction of the coil core 12.

Preferably, due to its hollow cylindrical construction, the coil core 12 is arrangeable on an axis accommodation 30 which is shown in FIGS. 2, 3. Preferably, the coil core 12 is plugged onto the axis accommodation 30 and held there in a torque-proof manner. In this context, torque-proof means that after the operative arranging, the element coil 10 and the axis accommodation 30 do no longer rotate relative to each other.

On this basis, it is preferred that the element coil 10 is rotatably driven with the help of the axis accommodation 30 so as to coil-on or wrap off the belt band 7 in a controlled manner. Furthermore, this arrangement preferably provides the possibility of stopping a movement of unwrapping of the element coil 10. Furthermore, the axis accommodation 30 preferably serves for holding the element coil 10 at a defined position and fasten it in the space, in order to determine a supply path of the elements via the belt band 7 to the processing device 1.

A first 14 and a second side wall 16 are respectively arranged adjacent to a first and a second axial end of the coil core 12. The first 14 and the second side wall 16 delimit an intermediate coiling space 18 for the belt band 7 on the coil core 12. Preferably, the side walls 14, 16 are round and thus configured annular around the coil core 12. However, other forms, e.g. polygonal configurations similar to a square or a polygon, are also possible, as long as they provide a delimiting surface segment 20 directed to the coiling space 18 and a surface segment 22 directed axially to the outside for a mechanical identification connection 40 that is discussed below.

The surface segment 20, which is axially directed to the inside, preferably retains the belt band 7 with the magazined elements on it (not shown) in the coiling space 18 on the coil core 12.

According to a first preferred embodiment of the axis accommodation 30, same comprises an axial attachment wall 34 next to a cylindrical portion 32 for receiving and retaining the coil core 12. The axial attachment wall 34 protrudes in radial direction from the cylindrical portion 32. The attachment wall 34 delimits the cylindrical portion 32 of the axis accommodation 30 in axial direction, so that the coil core 12 of the element coil 10 is axially arrangeable on the cylindrical portion 32 only until the surface segment 22, which is directed axially to the outside, of the first side wall 14 abuts the attachment wall 34 completely or partly.

The cylindrical portion 32 is preferably configured hollow-cylindrically, which is indicated by the hatched ring in FIG. 3, illustration on the right side. Likewise, it is also preferred that the cylindrical portion 32 be provided as a solid cylinder.

At least one first complementary object 42 is arranged at the axial outside 22 of the first side wall 14 of the element coil 10 for forming the mechanical identification connection 40 with the axis accommodation 30. At least a second complementary object 44 is arranged at the attachment wall 34 of the axis accommodation 30. The at least one first complementary object 42 and the at least one second complementary object 44 jointly form two matching and mutually corresponding constructive objects which due to their engaging form the mechanical identification connection 40.

If the identification connection 40 does not occur, belt-magazined elements of the wrong configuration, which are magazined in the belt band 7 of the element coil 10, are hindered from being loaded into the supply device 9 or the processing device 1 and processed there. The practicable possibility of exclusion by interpreting the identification connection 40 supports an automized loading or equipping of processing devices 1, as the identification connection 40 which is not established due to non-matching first 42 and second complementary objects 44 which encounter one another prevents an operative arrangement of the element coil 10 on the axis accommodation 30.

The first 42 and second complementary objects 44 are designs which match one another. The complementary objects 42, 44 may generally be divided into pairs of male and female complementary objects 42, 44. FIG. 22 for example shows first female complementary objects 42 in the form of an opening or indentation. They are preferably engaged by the two male second complementary objects 44 of the axis accommodation 30 (see FIG. 3), thus forming a suitable mechanical identification connection 40.

If for example only one opening was provided as the first complementary object 42 at the element coil 10, both second complementary objects 44 could not be accommodated at the axis accommodation 30 in a suitable manner. Accordingly, the identification connection 40 would not occur. Furthermore, the non-accommodated pin-like second complementary object 44 at the axis accommodation 30 would hinder an operative arrangement of the element coil 10 at the axis accommodation 30 as the element coil 10 could not be installed at the attachment surface 34 abutting the axis accommodation 30.

The first 42 and the second complementary objects 44 are preferably provided as male and female or as convex and concave designs. In this context, it is not relevant if the male and female designs are arranged as first 42 and second complementary objects 44 at the element coil 10 and the axis accommodation 30 or vice versa.

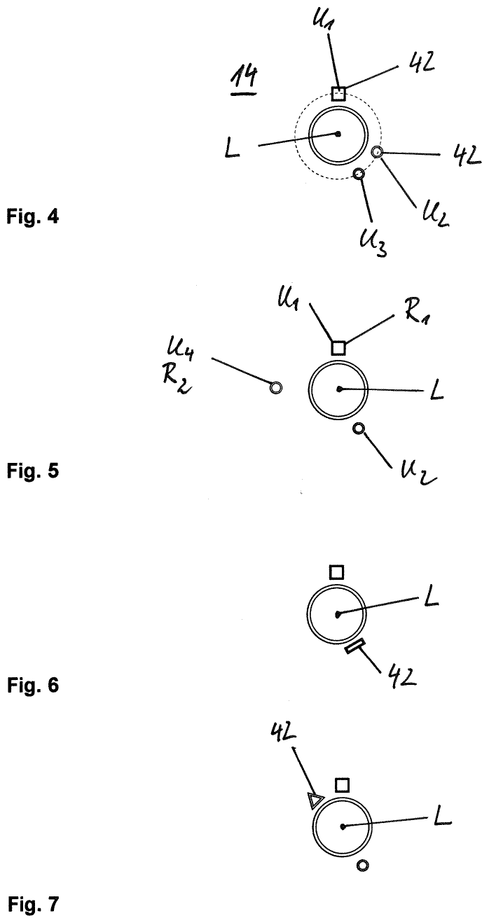

FIGS. 4-7 schematically show first complementary objects 42 at the first side wall 14 of the element coil 10. As the first 42 and the second complementary objects 44 are designed so as to match one another, the following statements mentioned with respect to the first complementary objects 42 as an example apply analogously to the second complementary objects 44, too.

The first complementary objects 42 which are shown in FIGS. 4-7 have a round, oval, angular, multi-angular or polygonal outer contour. Furthermore, it is preferred that complementary objects 42 of the same form be dimensioned differently. For example, a pin like complementary object 42 of a first configuration has a smaller outer diameter than a pin like complementary object 42 of a second configuration.

It is furthermore preferred that a plurality of first complementary objects 42 be provided which are arranged at different circumferential positions U with respect to the longitudinal axis L (see dashed line in FIG. 4).

It is furthermore preferred that a plurality of first complementary objects 42 be provided at different radial positions R and/or different circumferential positions U, as shown in FIG. 5. A radial position R is defined by means of the radial distance of the first complementary object 42 to the longitudinal axis L.

Based on the different number, shape, dimension, circumferential position and radial position of the complementary objects 42 at the side wall 14, configuration patterns are preferably defined from which a configuration of the elements magazined on the element coil 10 can be gathered.

In case of punch rivets in the sheet-processing industry, there are, for example, at least 10 basic geometry classes. Here, four common diameter variants of three hardness levels are typically used. In addition, the rivets are offered with three different coatings and at 22 length levels of 3 mm to 14 mm, leading to at least 7920 pattern variations.

In order to be able to illustrate all rivet variants, five circle lines for the five rivet parameters, which are sufficiently spaced from one another, are defined on the side wall of the coil. On the circle lines, the index positions are realized in form of holes. The first circle line identifies the geometry class, the second the diameter, the third the length, the fourth the hardness and the fifth the coating.

Independent of that, the biggest hole is the basic position which interrupts the circle lines. In this context, the radial distance of the respective index position to the basic position (angular distance) corresponds to a parameter configuration. The index positions are evenly distributed on the respective circle line and are also sufficiently spaced from one another, comparable to the minute positions on a clock face. This configuration is preferably also describable in a polar coordinate system around the longitudinal axis L.

For a preferred rivet with the configuration C 3.5×3 H2 Almac, the respective first index position in clockwise direction directly next to the basic position is selected. In case of a J rivet, the second position on the first circle line is blocked, and so on.

According to a further preferred configuration of the present invention, the first 42 and second complementary objects 44 are provided in the form of inserts or attachments. The inserts and attachments determine the form of the respective complementary object 42, 44. Preferably, the inserts are fixed in installation openings of the side wall 14 or the attachment wall 34. Likewise, fastening points or fastening locations at the side wall 14 and/or the attachment wall 34 can be provided in order to fasten respective attachments there.

In this context, the element coils 10 are provided as blanks without complementary objects, but with installation openings and/or fastening positions. As soon as the element coils 10 are loaded or magazined or before that, the complementary objects 42, 44 are arranged in the installation opening and at the fastening positions according to the customer's wish.

The preferred retrospective configuration of the element coil serves the purpose that the blanks can be produced in large amounts in order to keep costs low. Furthermore, the configuration does not have to be determined, documented and surveilled centrally in advance (i.e. by the producer), but only by the final customer at the factory. As the final customer usually does not process the complete range of element variants, it is not necessary to provide each variant with its own configuration, as is for example the case with an identification code. Rather, the configuration can be adapted to the end customer's need, e.g. to the number of variants of elements to be processed.

Preferably, inserts and attachments are plugged-in or plugged on and locked by means of hooks, latching noses (similar to a cover of a battery case) to radial and/or circumferentially spaced index positions without tool. The latching noses are preferably accessible from the rear, only, and cannot be released without a special tool, which serves the manipulation protection. Regarding the coil core 30, the latching noses are for example covered by the belt band. For the engagement of the special tools and releasing of the latching noses, there are little openings in the coil core or the axis accommodation, respectively. Preferably, the same applies to the axis accommodation, whereas there, the latching noses latch themselves in blind bore holes and are therefore accessible from one side, only.

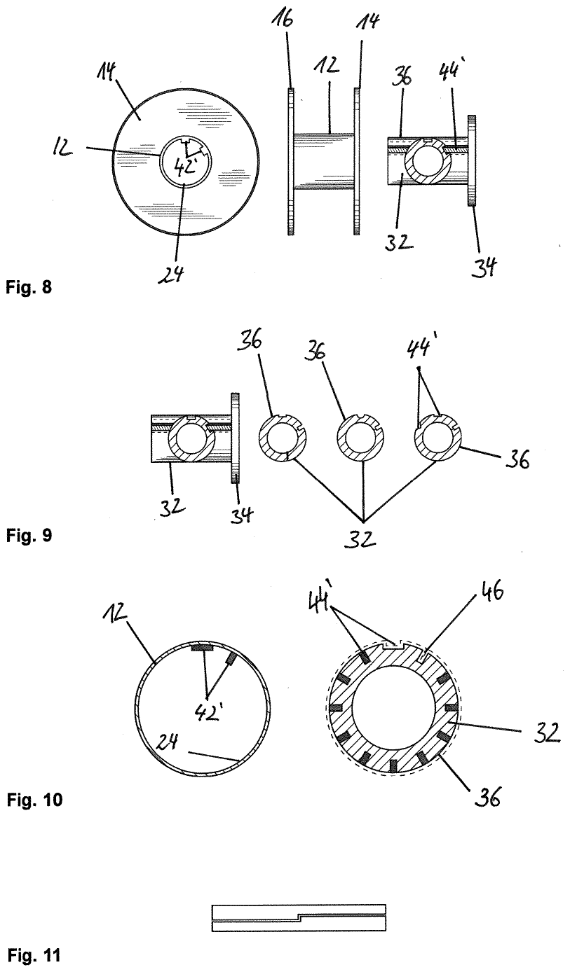

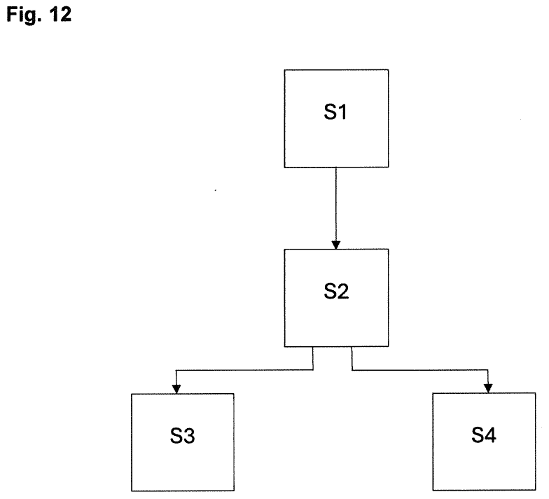

A further preferred embodiment of the present invention is schematically illustrated in FIGS. 8-11. Accordingly, the principle of the interacting complementary objects 42, 44 at opposing surface segments of the side wall 14 of the element coil 10 and the attachment wall 34 of the axis accommodation 30 is shifted to opposing surface segments at the radial inside 24 of the coil core 12 and the radial outside 36 of the cylindrical portion 32 of the axis accommodation 30.

The complementary objects 42′, 44′ are formed by male and female or convex and concave form designs at the radial outside 36 and the radial inside 24. For example, preferably the radial inside 24 of the coil core 12 comprises radially projecting, male complementary objects 42′. Preferably, they engage into indentations 44′ adapted in their form, i.e. female complementary objects.

The different design of the indentations 44′ in FIG. 9 preferably accommodates differently formed radially projecting complementary objects 42 of the coil core 12. It is clear that the male and female complementary objects 42′, 44′ may be distributed arbitrarily to the coil core 12 and the cylindrical portion 32 of the axis accommodation 30.

Furthermore, it is preferred that the radially projecting complementary objects 42′ be formed on the radial inside 24 of the coil core 12 by installation inserts or attachments. Same are preferably releasably fixed at fastening locations. That way, the coil core 12 and the axis accommodation 30 may be adapted to different element configurations, as was analogously described above.

According to another constructive design, indentations 46 are provided at the radial outside 36 of the cylindrical portion 32. Preferably, they serve for receiving an insert for forming a male complementary object 44′. In the same way, preferably, they serve as a female complementary object 44′ when without insert or as a female complementary object 44′ of a specific concave inner form when with an insert that does not project radially.

Furthermore, available indentations 46 can preferably be closed with an insert in order to show an element configuration.

The configuration adaptation and form design described based on the radial outside 36 of the cylindrical portion 32 can be transferred to the radial inside 24 of the coil core 12 in the same way. Accordingly, indentations (not shown) are preferably formed at the radial inside 24 in order to arrange corresponding inserts in there. Analogously, preferred fastening locations can also be provided at the radial outside 36 of the cylindrical portion 32.

With the above-described element coil 10, the present invention also uses a loading method of the processing device, which was also described above, by loading the belt-magazined elements into the processing device, preferably a setting device with the help of the element coil 10. For this purpose, the loading method comprises the following steps which are schematically illustrated in the flow chart of FIG. 12.

In a first step L1, the belt-magazined element coil 10 with at least one first complementary object 42; 42′ is arranged on the axis accommodation 30. While arranging the element coil 10 on the axis accommodation 30, the identification connection 40 between the element coil 10 and the axis accommodation 30 is established by connecting the at least one first complementary object 42; 42′ of the element coil 10 with the at least one second complementary object 44; 44′ of the axis accommodation 30 (step L2).

If the at least one first 42; 42′ and the at least one second complementary object 44; 44′ do not match, the element coil 10 is rejected in step L3. If, however, the at least one first 42; 42′ and the at least one second complementary object 44; 44′ match, the element coil 10 is locked on the axis accommodation 30 in step L4.

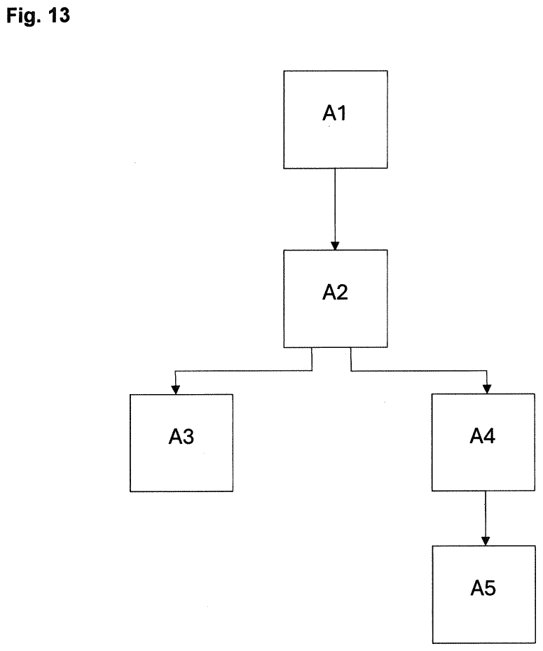

Furthermore, the present invention discloses a coiling method of an element coil 10 according to at least one of the above-described configurations with the belt band 7, in which elements to be processed are magazined. The coiling method is schematically illustrated in the flow chart of FIG. 13.

The coiling method comprises the following steps: in step A1, the element coil 10 with at least one first complementary object 42; 42′ is arranged on the axis accommodation 30. During the arranging, the identification connection 40 between the element coil 10 and the axis accommodation 30 is established in step A2 by connecting the at least one first complementary object 42; 42′ of the element coil 10 with the at least one second complementary object 44; 44′ of the axis accommodation 30.

In case the at least one first 42; 42′ and the at least one second complementary object 44; 44′ do not match, the element coil 10 is rejected in step A3. If, however, the at least one first 42; 42′ and the at least one second complementary object 44; 44′ match, the element coil 10 is locked on the axis accommodation 30 in step A4.

Once the element coil 10 has been locked on the axis accommodation 30 (step A4), the belt band 7 with belt-magazined elements is coiled on the element coil 10 in step A5 in order to form a belt-magazined element coil 10.

### 6. LIST OF REFERENCE SIGNS

1 processing device
3 setting device
5 C frame
7 belt band
9 supply device
10 element coil
12 coil core
14, 16 side wall of the element coil 10
18 coiling space
20 surface segment of the side wall to the coiling space 18
22 surface segment of the side wall axially to the outside
24 radial inner side of the coil core 12
30 axis accommodation
32 cylindrical portion
34 attachment wall
36 radial outside of the cylindrical portion
40 identification connection
42, 42′ at least a first complementary object at the element coil 10
44, 44′ at least a second complementary object at the axis accommodation 30
46 indentation
90 retaining web of the supply device 9
L central longitudinal axis of the element coil 10
U circumferential position

1. A belt-magazined element coil to which a belt band with small-scale elements that are releasably fastened in it can be coiled and which comprises:
a. a hollow-cylindrical coil core with a central longitudinal axis and a first and a second axial end onto which the belt band can be coiled, from which the belt band can be uncoiled in a controlled manner and which is arranged on an axis accommodation torque-proof for carrying out a rotating coiling movement,
b. a side wall is arranged at the first and the second axial end of the coil core, which laterally delimit an intermediate coiling space for the belt band on the coil core,
c. the coil core and/or at least one of the side walls of the coil are designed in shape such that based on a positive mechanical identification connection between the axis accommodation and the coil, a mechanical connection between same is enabled in that when arranging the coil on the axis accommodation, at least a first complementary object at the coil and at least a second complementary object at the axis accommodation suitably engage one another, by that allowing the connection instead of blocking it.

2. The belt-magazined element coil according to claim 1, wherein the at least two complementary formed first and second complementary objects at the coil and the axis accommodation, which form a suitable connection, are made of an elevation and an opening or indentation accommodating this elevation, each having a round or angular or curvilinear circumferential form.

3. The belt-magazined element coil according to claim 1, wherein the side wall of the coil comprises at least a first complementary object which, with respect to the central longitudinal axis, is arranged at a defined radial position and, with respect to a lateral surface of the side wall, at a defined circumferential position around the central longitudinal axis.

4. The belt-magazined element coil according to claim 3, in which a plurality of first complementary objects are arranged at the same radial position and different circumferential positions or at the same circumferential position and different radial positions or at combinations of the above arrangement alternatives, in order to identify a defined, small-scale element of the belt-magazined element coil.

5. The belt-magazined element coil according to claim 3, wherein at least two of the plurality of first complementary objects have different forms or different dimensions of the same forms.

6. The belt-magazined element coil according to claim 3, in which the at least one first complementary object is made of an exchangeable identification attachment or insert, which interacts with an integral or an exchangeable identification attachment or insert at the axis accommodation.

7. The belt-magazined element coil according to claim 1, the hollow cylindrical coil core of which comprises, at a radial inside, at least a first complementary object which forms a suitable connection with at least a second complementary object at a radial outer side of the axis accommodation or is capable of blocking a connection between coil core and axis accommodation.

8. The belt-magazined element coil according to claim 6, in which the at least one first complementary object at the radial inside of the hollow cylindrical coil core is made of a radially projecting identification attachment or an identification indentation or of a radially projecting identification insert that is inserted into an indentation or of a combination of same, and the at least one matching second complementary object at the radial outside of the axis accommodation is made of a suitable indentation for the identification attachment or the radially projecting identification insert or of a matching radially projecting attachment for the indentations at the coil core.

9. A supply device of a processing device of small-scale elements having at least an axis accommodation with at least a second complementary object matching at least a first complementary object of the belt-magazined element coil according to claim 1 and which is fastenable at the processing device.

10. The supply device according to claim 9, the axis accommodation of which comprises a cylindrical receiving portion for the hollow cylindrical coil core of the element coil, at the radial outer side of which at least a second complementary object is provided as a radial projection or a radial indentation.

11. The supply device according to claim 9, in which a radially extending attachment wall is provided at the axis accommodation, to which a side wall of the element coil is attachable in order to form an identification connection between at least a second complementary object at the attachment wall and at least a first complementary object at the side wall of the element coil.

12. The supply device according to claim 11, in which the attachment wall comprises, as an at least second complementary object, an axial projection in axial direction of the cylindrical receiving portion or an indentation or opening in a direction facing away from the cylindrical receiving portion.

13. A processing device for small-scale elements comprising the supply device according to claim 9, in which the small-scale elements are releasably fastened in a belt band, the belt band is coiled on the belt-magazined element coil and the belt-magazined element coil with belt-magazined elements is arranged in the supply device, wherein at least one element coil with belt-magazined elements can rotatably and exchangeably be loaded on an axis accommodation into a supply device of the processing device only on the basis of a positive mechanical connection identification, so that with the help of the supply device, the small-scale elements are suppliable to the processing device.

14. A coiling device with which belt-magazined elements are coilable on the belt-magazined element coil according to claim 1 and which comprises an engine-driven axis accommodation with at least one second complementary object, so that a belt band with belt-magazined elements may be coiled or uncoiled in a controlled manner onto or from the element coil, equipped with the at least one first complementary object matching the at least one second complementary object of the axis accommodation.

15-16. (canceled)
